(19) United States
(12) Patent Application Publication
(10) Pub. No.: US 2003/0015416 A1
(43) Pub. Date: Jan. 23, 2003

(54) Apparatus for stimulating removal of electrolytic energy from fluids

(76) Inventors: Robert F. Meeeh II, Fenton, MO (US); Stephen C. Scott, Waco, TX (US)

Correspondence Address: Paul M. Denk, 763 South New Ballas Road, St. Louis, MO, 63141, US

(21) Appl. No.: 10/186,144

(22) Filed: Jun. 28, 2002

Related U.S. Application Data
(60) Provisional application No. 60/301,976, filed on Jul. 2, 2001.

(51) Int. Cl. G01N 27/26

(52) U.S. Cl. 204/194; 205/775

(57) ABSTRACT

A control unit for an apparatus for removal of electrostatic charge and electricity from fluids, including a probe apparatus for extending into the contained fluids, a control unit, circuitry interconnecting between the grounding apparatus and the control unit, control unit providing for monitoring the conductivity or mineral content of the fluid stream, while the grounding apparatus removes the mineral salts and trace minerals and other electrolytic charge from the fluids, while additional circuitry within the control unit reduces the fouling of a re-circulating fluid stream normally caused by the growth of various kinds of algae, molds or bacteria.

### CROSS-REFERENCE TO RELATED APPLICATIONS

This application is non-provisional patent application based upon provisional patent application having Serial No. 60/301,976, filed on Jul. 2, 2001, which is owned by the same inventors.

### STATEMENT REGARDING FEDERALLY SPONSORED RESEARCH OR DEVELOPMENT

Not Applicable.

### BACKGROUND OF THE INVENTION

This invention relates generally to water treatment equipment, more specifically to improvements associated with a means for effectively removing electrolytic energy from within a vessel of water, such as an industrial or domestic water heater. The improvements include an electronic controller, a conductivity sensor, and a biocide circuit.

The deposit of mineral material upon metallic or other surfaces, especially conductive surfaces located within water handling and treating equipment has long been a problem associated with this particular art. The existence of mineral trace elements within water or other fluids being treated by the aforesaid type of equipment has long plagued the industry. In fact, tubes or piping that connect with water handling and treating equipment, particularly hot water boilers, can lead within a relatively short period of time to calcium and other mineral deposits that substantially block or very nearly curtail the flow of water. This blockage substantially decreases the efficiency of the operation of such equipment. It is believed that mineral deposits occur as a result of electrolytic action that does take place within the water processing equipment. The fact that such mineral deposition takes place can be observed by examining the interior of any water pipe that is constructed of iron, copper, or any other conductive material. The mineral deposits that uniformly form a scale around the entire inner circumference of the pipe can be readily seen.

Not only are the pipes attacked by mineral deposits, any type of apparatus that requires the use of water or other conductive liquid are also subject to such deterioration. Boilers, water heaters, condensers, bottle washers, pasteurizers, water coolers, and related equipment, are all of the type of equipment that can be subject to the formation of scale upon their inner surfaces, particularly if these devices are formed of a conductive material.

The provision of some means which can effectively ground or diminish the electric charge within these types of devices can significantly reduce the damage previously sustained by such water handling mechanisms. This effect is fully explained in prior U.S. Pat. Nos. 4,147,607 and 4,514,273. Additionally, it is now known that formation of scale itself upon the inner surfaces of water treating apparatuses is not the only damage perpetrated by this action. Such scale formation can also give rise to pitting and other deterioration at the scale-metal interface resulting in eventual corrosion of the metallic surface. This is one of the main causes for the demise of water heaters because internal corrosion of the heater, particularly the surface exposed to water, eventually corrodes to the point of failure.

Various types of water treating equipment are generally known in the prior art, and have provided limited success in achieving reduction of mineral deposit and scale. However, many of these devices have not recognized the need to obtain the most effective removal of electrostatic charge. For example, this can be readily seen in the prior U.S. Pat. No. 2,499,670 to Neeley, wherein the electrode itself connects through supporting structure to the outer sheet of the boiler. Thus, any grounding achieved in this manner has reduced benefits against the formation of scale upon the inner surfaces of the boiler shown in that patent. Earlier U.S. Pat. Nos. 2,893,938, 2,975,769, 3,595,774, and 3,620,951 to Bremerman, have recognized the necessity to insulate the electrode from the reservoir surface so that a more effective grounding of the electrode can be made. These Bremerman style of devices are problematic, however, because the mounting component for the electrode was usually constructed of a Bakelite material, or some other form of resin insulator. These types of insulators have been found to exhibit a pronounced tendency to absorb moisture thereby reducing the insulating effect of the insulator mounting and allowing electrical grounding to occur. Thus, while these types of prior art electrodes are effective in their early stages of use, they eventually deteriorate due to their prolonged exposure to the moisture within the vessel, and thus eventually and substantially decrease their ability to inhibit mineral deposit and scale formation.

### BRIEF SUMMARY OF THE INVENTION

It is therefore an object of this invention to provide a control unit for an apparatus for the removal of electrostatic charge and electricity from the fluid passing through fluid handling equipment.

Another object of the present invention is to incorporate within the control unit, a circuit means for automatically measuring and displaying the level of electrostatic charge present in the fluid passing through the fluid handling equipment.

A further object of this invention is to incorporate, into the control unit, a circuit means to monitor the conductivity or mineral content of a re-circulating fluid stream, and to automatically drain accumulated sediment when a predetermined conductivity level is attained.

It is yet another object of this invention is to incorporate a circuit means into the control unit which reduces the amount of fouling in a re-circulating fluid stream caused by the growth of various kinds of algae, molds, and bacteria through the controlled addition of copper and silver ions to the fluid stream.

This invention is designed to further enhance the use and application of grounding devices within fluid handling equipment to remove more efficiently the electrostatic or electrolytic charge normally inherent within many of the fluids being processed. As is known, the essence of this type of invention is to provide for a device which is better electrolyzed than the fluid being processed by such fluid handling equipment. By doing so, the mineral salts or trace minerals will not be electrolytically deposited onto the contact surfaces within the fluid handling equipment by means of electric charge. Rather, the electric charge will be sent to ground by means of the grounding apparatus of this invention, thereby eliminating the impetus which normally induces mineral conveyance through the water. Thus, the improvement of this particular invention resides in the provision of control unit, including circuit means, to monitor and adjust the conditions of the fluid within which the apparatus is immersed.

More specifically, a circuit means is provided within the control unit to automate the function of obtaining measurements of the electrostatic or electrolytic charge contained within the fluid. The circuit means will periodically disconnect the apparatus from the electrical ground, and integrate a voltage measurement obtained from the apparatus. The circuit means then displays the result of the voltage measurement. This eliminates the need for a field technician to manually disconnect the electrical ground and take voltage measurements.

A second circuit means is provided within the control unit to automate the monitoring of the fluid conductivity or mineral content in a re-circulating fluid stream. Upon detection of a conductivity level or mineral content exceeding a predetermined value, the circuit means opens a valve to flush away any deposited sediment located within the fluid handling apparatus.

Finally, a third circuit means is provided within the control unit to automatically reduce fouling of a re-circulating fluid stream caused by the growth of various kinds of algae, molds, or bacteria. The circuit means controls the flow of current to a pair of electrodes, selectively releasing copper and/or silver ions into the fluid stream. The copper and/or silver ions are toxic to the growth of algae, molds, and bacterial. The control circuit is capable of adjusting the current flow to compensate for the reduction in mass of the electrodes and to obtain the desired ion dispersion level.

The foregoing and other objects, features, and advantages of the invention as well as presently preferred embodiments thereof will become more apparent from the reading of the following description in connection with the accompanying drawings.

### BRIEF DESCRIPTION OF THE SEVERAL VIEWS OF THE DRAWINGS

In the accompanying drawings which form part of the specification:

FIG. 1 is an isometric view of a probe-style conductive member;

FIG. 2 is a side view of the probe-style conductive member shown in FIG. 1;

FIG. 3A is a front view of the weatherproof housing for a first embodiment of the present invention;

FIG. 3B is an internal view of the weatherproof housing of FIG. 3A, illustrating the placement of the internal components;

FIG. 4A is a front view of the weatherproof housing for a second embodiment of the present invention;

FIG. 4B is an internal view of the weatherproof housing of FIG. 4A, illustrating the placement of the internal components;

FIG. 5A is a front view of the weatherproof housing for a third embodiment of the present invention;

FIG. 5B is an internal view of the weatherproof housing of FIG. 5A, illustrating the placement of the internal components;

FIG. 6 is a schematic circuit diagram of the millivolt probe controller circuit;

FIG. 7 is a schematic circuit diagram of the biocide controller circuit; and

FIG. 8 is a schematic circuit diagram of the conductivity controller circuit.

Corresponding reference numerals indicate corresponding parts throughout the several figures of the drawings.

### DESCRIPTION OF THE PREFERRED EMBODIMENT

The following detailed description illustrates the invention by way of example and not by way of limitation. The description will clearly enable one skilled in the art to make and use the invention, describes several embodiments, adaptations, variations, alternatives, and uses of the invention, including what we presently believe is the best mode of carrying out the invention.

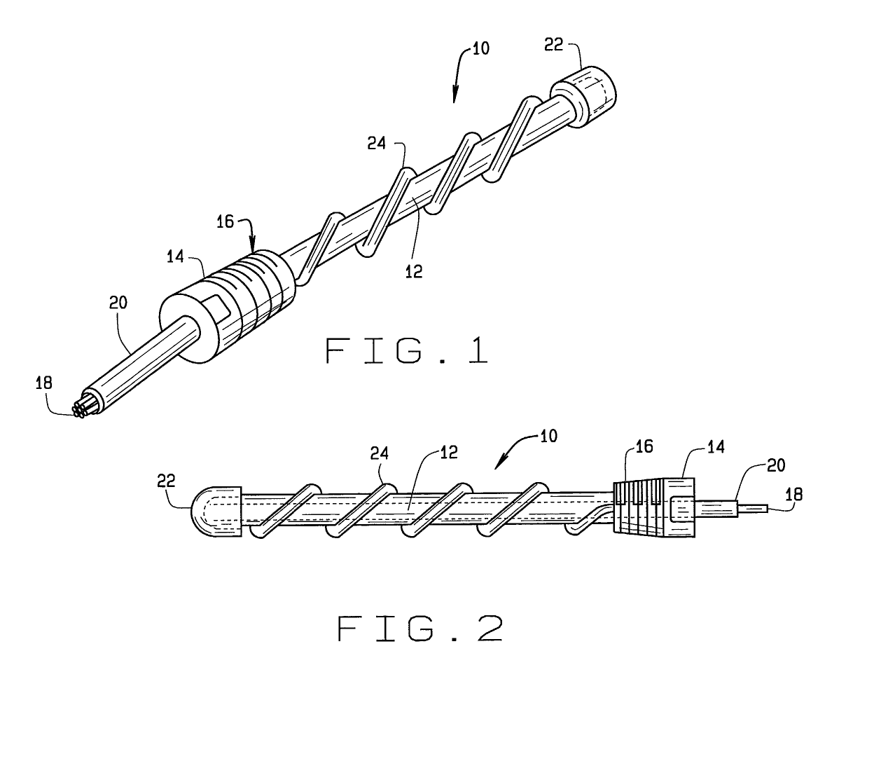

Referring now to the drawings, FIG. 1 and FIG. 2 discloses a grounding apparatus 10 used which incorporates a conductive member 12 which extends for some length. When incorporated within and connected to the wall of the fluid handling equipment, the conductive member 12 extends for some distance therein so as to assure adequate exposure and contact with the fluid flowing through such equipment. The conductive member 12 has connected to one end a mounting means 14 which comprises a non-conductive material having threads 16 which engage with matching threads within a liner or jacket of a vessel in a fluid handling apparatus. A conductor 18 carrying its insulation 20, extends into and through the mounting means 14. The conductor 18 extends for the full length through the conductive member 12 and is generally connected by means of brazing, or the like, to the inserted end 22, of the grounding apparatus 10. As described in U.S. Pat. No. 4,514,273, a rod-like member 24 may project upwardly from the surface of member 12, and extend longitudinally thereof, wound around the outer surface of the conductive member 12 in a helical manner to increase the surface area of the conductive member in contact with the fluid passing through the fluid handling equipment, assuring the maximum efficiency in the grounding of electrostatic charge out of the fluid.

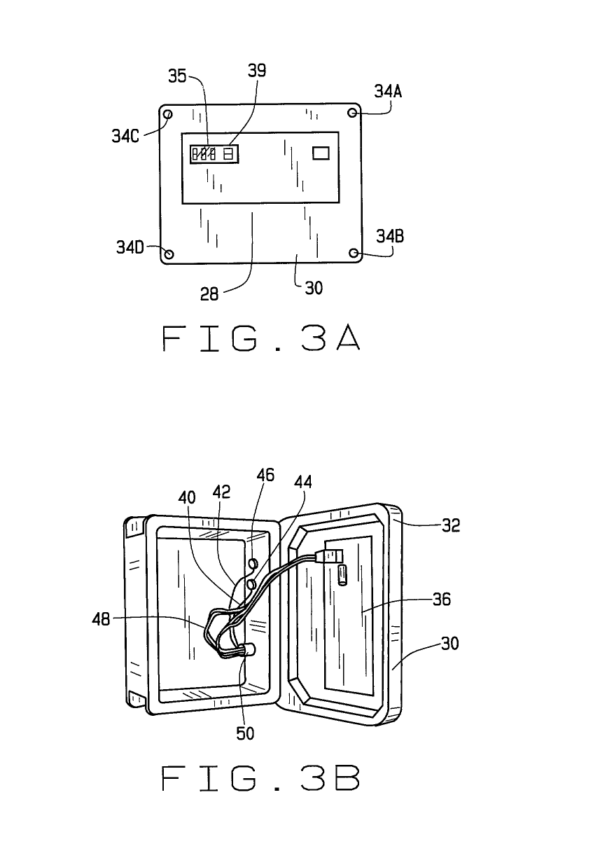

Turning to FIG. 3A through FIG. 5B, the improvement of this invention, a control unit for use with the aforementioned grounding apparatus 10, is shown generally at 28. The control unit is enclosed within a weatherproof housing 30, and is accessed through a hinged cover 32 secured by means of screws 34A-34D.

FIG. 3A and FIG. 3B illustrate a first embodiment of the control unit 28 incorporating a millivolt probe controller circuit 36, mounted vertically within housing 30. One skilled in the art will recognize that the controller circuit 36 may be mounted at any desired orientation in the housing 30 and still remain within the scope of the invention. The probe controller circuit 36 includes a four element LCD display DISP1-4 35 (FIG. 3A), visible on the hinged cover 32 (FIG. 3B) of the housing 30 through a weatherproof, transparent membrane 39. Grounding wires 40 and 42 are secured to grounding points 44 and 46 respectively within the housing 30, while probe connection wires, indicated generally at 48, pass through a weatherproof bushing 50 for connection to a remote millivolt probe (not shown).

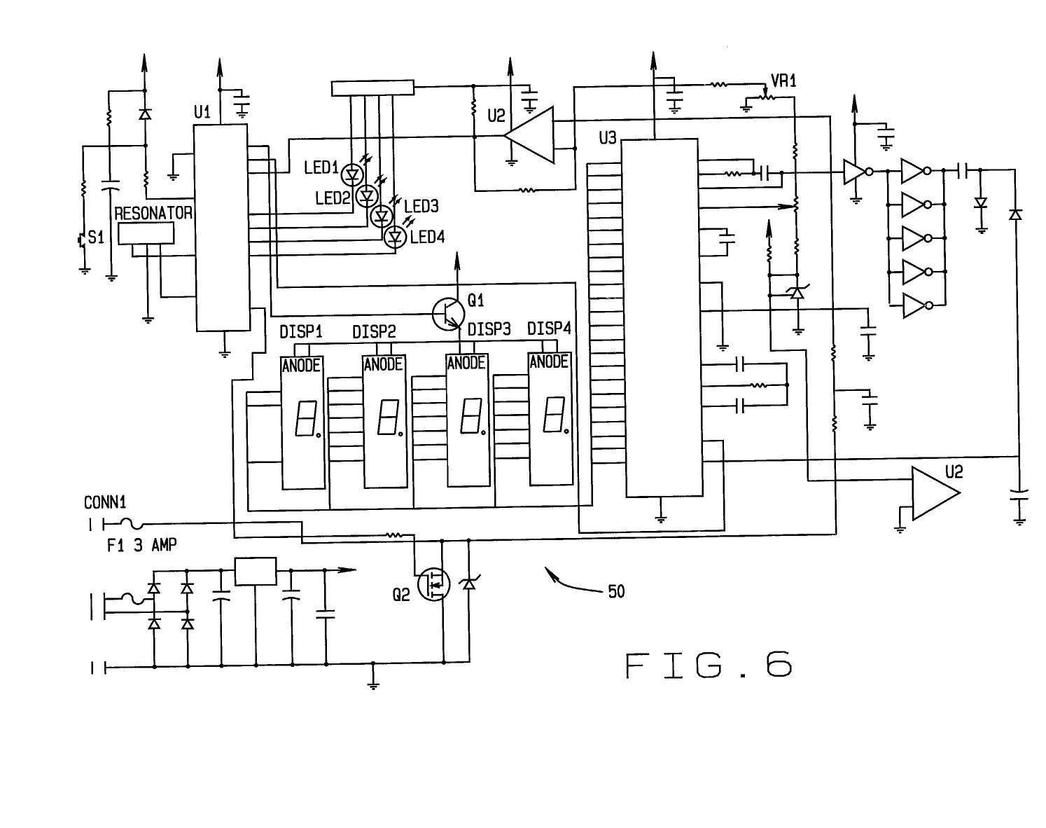

Turning to FIG. 6, the millivolt probe controller circuit is indicated generally at 50. The probe controller circuit is designed to automate the function of measurements indicating the voltage level of electrostatic charge contained with the fluid flowing past the grounding apparatus 10 within the fluid handling apparatus (not shown). This automates the procedure of having a field technician manually remove the grounding straps from the probe and then take the measurements. The processor within the controller utilizes so-called “fuzzy logic.” The code for this circuit is attached as Appendix A and subtitled “probe-a.asm.” The use of adaptive technology which is accomplished by the use of this “fuzzy logic” in the microprocessor microcode allows this system to adapt to changing conditions. This allows greater freedom in the deployment of the system. It also does not require a skilled technician to install, or maintain it. The results are more consistent, viable, sensitive, and in general more usable for the client.

The grounding apparatus is electrically connected to the controller circuit at the connection indicated CONN1 through a 3 amp fuse. A field effect transistor Q2 is energized to drain whatever charge has built up in the fluid flowing past the grounding apparatus to ground. Periodically, a processor U1 will signal for a measurement to be taken. At this time, the processor U1 will remove the control from the field effect transistor Q2, thus isolating the grounding apparatus from ground.

Simultaneously, the processor will illuminate a light emitting diode LED2, indicating that a measurement cycle has begun. The charge continuing to build up on the grounding apparatus is now directed to an analog to digital converter U3, which interprets the voltage level, and displays the result on the four digit liquid crystal display DISP1-4. Upon completion of the measurement cycle, the processor U1 extinguishes LED2, and illuminates a second light emitting diode, LED3 to indicate that the value displayed on DISP1-4 is a valid reading of the current voltage level recorded at the grounding apparatus, as measured in millivolts. The processor U1 further serves to compare the current voltage level recorded with a preset minimum value. Should the current voltage level fall below the preset minimum value, or the last four readings of the probe fall outside the readings anticipated by the controller, processor U1 will illuminate a third light emitting diode, LED4 indicating the grounding apparatus should be visually inspected for damage. This probe check happens when the millivolt signal from the probe falls below a setpoint limit imposed by control voltage (VR1). In that instance, the comparator (U2) will send a signal to the processor (U1) at which time the processor (U1) will illuminate the LED (LED4) indicating the probe should be visually inspected as its millivolt signal is too low. A manual override switch S1 is provided, which, when activated, initiates a measurement cycle. In the event of power loss, the probe is directly connected to the ground by the relay RLY1 thus providing continuous grounding protection.

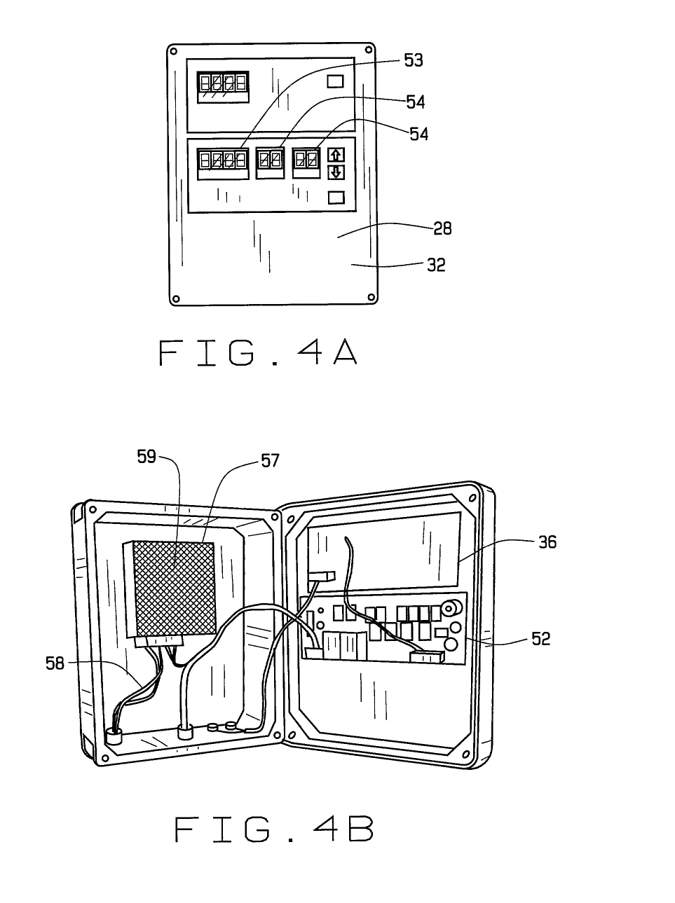

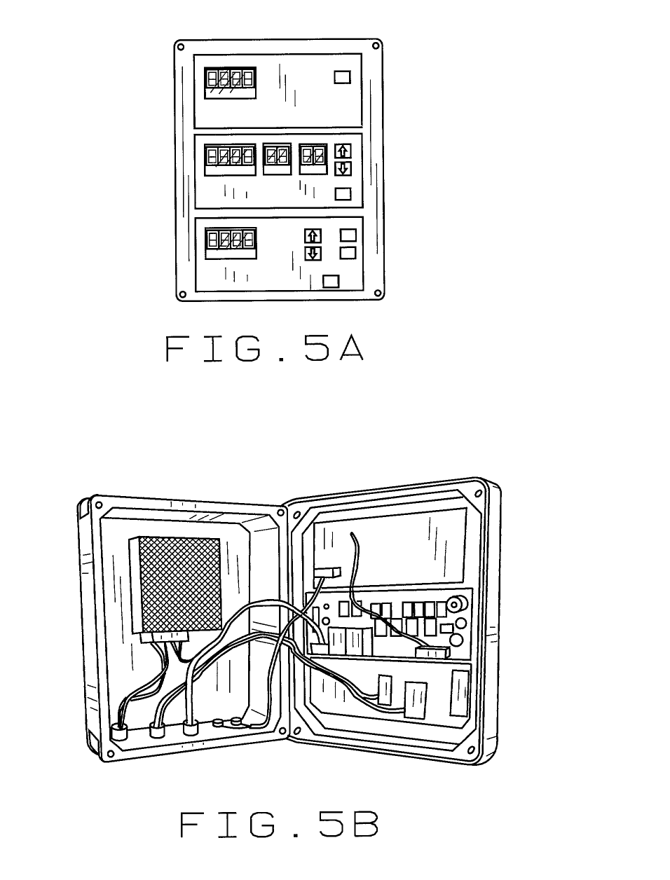

Turning to FIG. 4A and FIG. 4B a second embodiment of the control unit 28 is shown which incorporates a biocide module. This embodiment incorporates a horizontally mounted biocide controller circuit 52 in addition to the millivolt probe controller circuit 36 described above. The purpose of the biocide circuit is to reduce the amount of fouling in re-circulation plumbing caused by various kinds of algae, molds, bacteria, etc. by taking advantage of the fact that copper and silver ions are toxic to such organisms.

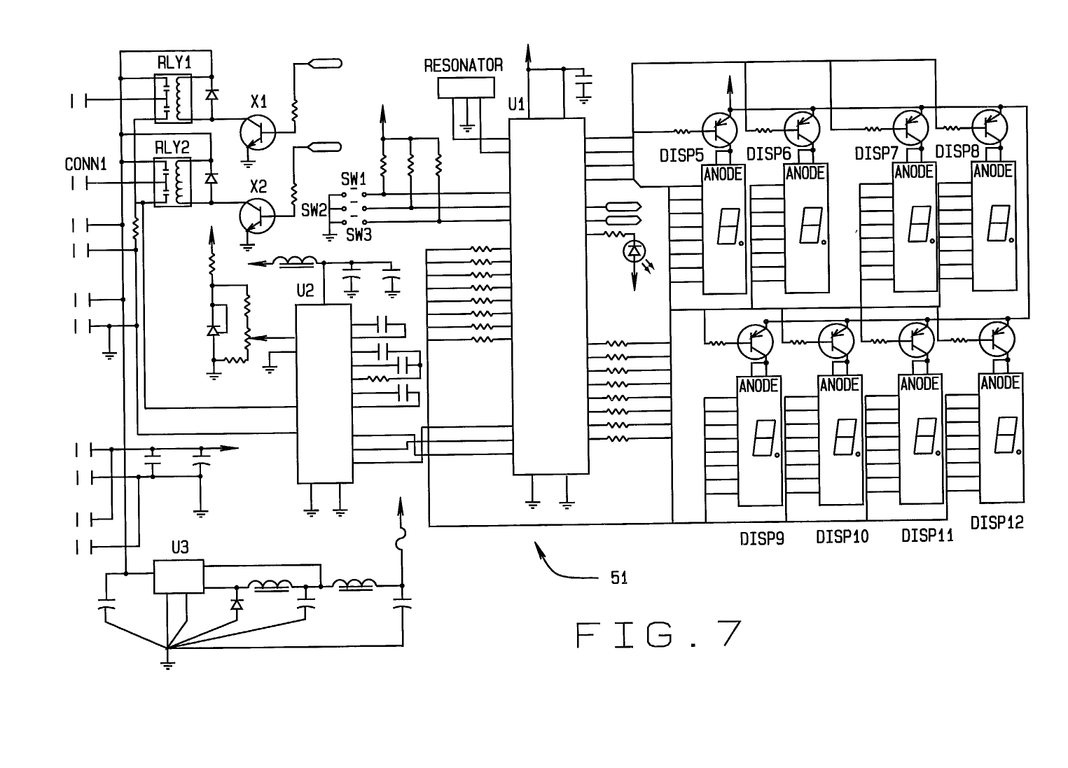

In FIG. 7 the biocide control circuit 51 is shown. The biocide circuit 51 is designed to automate a reduction in the amount of fouling in a re-circulating fluid stream caused by various kinds of algae, molds, and bacteria through the controlled application of copper and silver ions. The biocide control circuit is comprised of two components, an electrode 60 and a controller 62.

The electrode 60 contains silver, copper, and other metals in a form which allows a current to flow across the fluid. The controller 62 is configured to supply a 12 volts, 3 amps electric current to the electrode 60 via connection 64.

It is known that when an electrical current is passed through a conductive medium, the electrode metal will atomize and go into the solution via a process of electrolysis. It is this process that is used to control the growth of bacteria and algae in the water system. The atoms of silver and copper are toxic to bacteria, slime, molds, fungi, and other such organisms. When these fouling agents build up to a point where they constrict the flow or block flow altogether, the system is fouled. The timed, systematic release of these toxic silver and copper ions thwart the pro-generation of these agents.

The processor (U1) controls the biocide system. The microcode for the operation of the processor (U1) is attached as Appendix B subtitled “biocide.asm.”When pre-programmed conditions are correct (time or energy density), the processor (U1) calls for a toxin release cycle by activating relays RLY1 and RLY2 in such a manner that direct current electricity in one polarity is applied to the electrodes. After a preprogrammed interval of time has passed, the processor (U1) will reverse the polarity by switching the relays. This periodic reverse will not allow one electrode to diminish in its mass before the other one due to electrolysis. This periodic reversal polarity also has a secondary benefit. Because the controller has a 50% duty cycle, thereby switching the polarity evenly over time, the water has not net result electrical charge which could prove detrimental to the probe module.

In operation of the biocide module, the operator sets the initial starting point by INCREASING (SW3) or DECREASING (SW2) the starting point in minutes of the first cycle. This selected starting point value is committed to memory within the module by pressing SW1. The selected cycle time, in minutes, is displayed on liquid crystal display DISP9-10. The processor (U1) 60 takes this initial time and holds this value in a memory buffer. At initiation of the first cycle, the processor 60 reads the current draw in the electrode by using the analog converter (U2) 68. This value is displayed in DISP1-4 and is also stored in a memory location. The processor 60 then takes the product value of this initial cycle to be used as the standard by which all other cycles will be compared. During the next cycle, the original product value is compared to the present product value. If the products do not agree, the processor 60 then increases the time until the present product value equals the original stored product value. Here again “fuzzy logic” programming within the processor is particularly adapted for this type of operation.

While the processor is applying power to the electrodes, the current draw from the electrodes are constantly being monitored by the analog converter 68. The data gathered from this converter is fed into the processor and the TIME/CURRENT calculations are performed. These calculations are performed to keep a user-supplied TIME/CURRENT value constant. As the electrodes wear due to the sloughing of copper ions, its mass is reduced. The current drawn by a worn or mass-reduced electrode is much different than a new electrode in that the current draw is much lower. In order to keep the proper TIME/CURRENT value, the time must be increased as the current lowers due to the age of the electrode.

The ON time portion is changed (extended) every hour of operation. This will ensure the proper TIME/CURRENT ratio which ensures the proper amount of copper ions in solution. This again is the nature of the adaptive nature of the “fuzzy logic” within the microcode of the processor.

Referring again to FIG. 4A and FIG. 4B, the biocide controller circuit 52 includes a four-element LCD display DISP5-8 53, and a pair of two-element LCD displays 54, DISP9-10 and DISP11-12, each visible on the hinged cover 32 of the housing 30 through a weatherproof, transparent membrane 39, located adjacent to, and below, the millivolt probe controller components. Within the housing 30, the circuits 52 and 36 are secured to the inside of the hinged cover 32, with connecting wires, indicated generally at 58 connected to a power transformer element 57 secured to the rear interior surface of the housing 30. The power transformer element 57 is enclosed within a protective grill 59, designed to prevent accidental contact with the transformer while permitting airflow circulation.

Turning now to FIG. 5A and FIG. 5B, a third embodiment of the control unit 28 is shown. In this embodiment a conductivity module is incorporated in addition to the biocide controller circuit 52 and millivolt probe controller circuit 36 previously described above. The conductivity module comprises an electrode and a conductivity controller circuit 70. The purpose of conductivity controller circuit 70 is to monitor the conductivity or mineral content of the re-circulation stream. Based on this value, the controller will call for a valve to open which will drain the sediment located in the bottom of a boiler of a water processing system.

The conductivity controller circuit 70 includes a four-element LCD display DISP13-16 visible on the hinged cover 32 of the housing 30 through a weatherproof, transparent membrane 39, located adjacent to, and below, the biocide controller and millivolt probe controller components. Within the housing 30, the circuit 70 is secured to the inside of the hinged cover 32, with connecting wires, indicated generally at 72 connected to the remote conductivity sensor (not shown) and valve control mechanism (not shown) exiting the housing 30 through a weatherproof bushing 74. Grounding wires 76 link the conductivity circuit 70 with the biocide controller circuit 52, and the millivolt probe controller circuit 36 to provide for a common electrical ground connection.

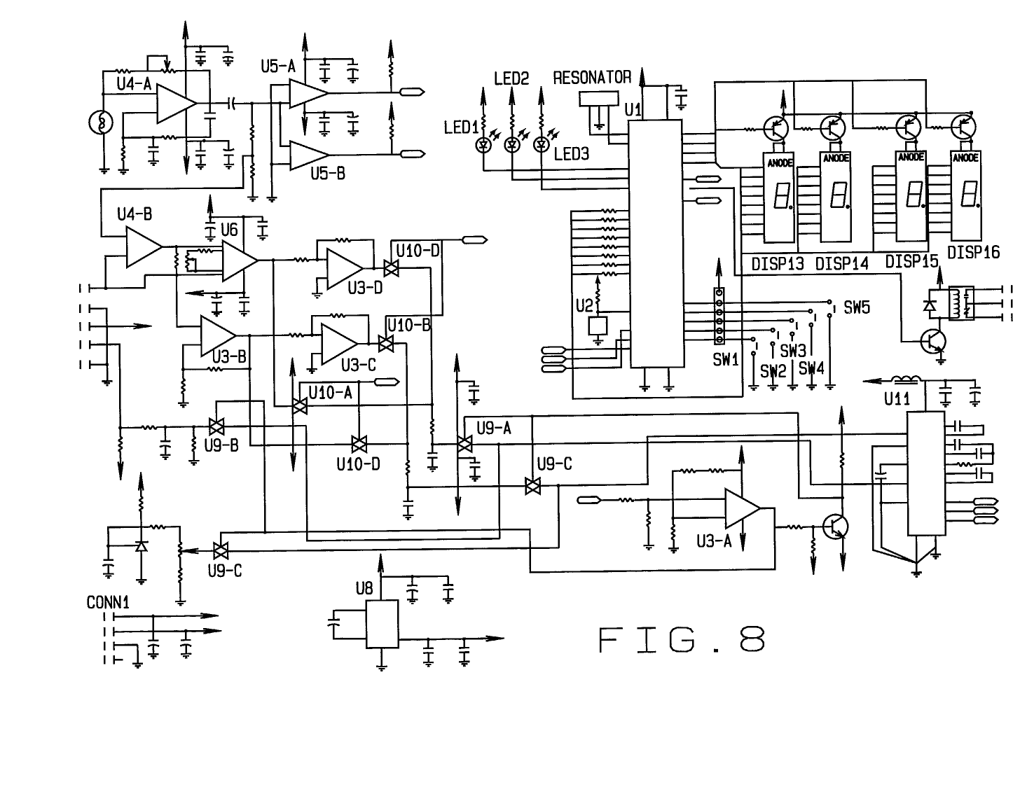

Referring to FIG. 8, the conductivity controller circuit 70 is designed to monitor the conductivity or mineral content of a recirculating fluid stream (not shown). Based upon the monitored value, the conductivity controller will actuate a valve in the fluid stream to flush out or drain any accumulated sediment located within the system.

In operation, a sine-wave of approximately 1000 Hz is generated by OP AMP (U1-A) of the conductivity controller circuit 70. This frequency is critical and is temperature stabilized by lamp (LMP). The other half of the OP AMP (U1-B) is used as a constant current source for the measurement of conductivity by utilizing resistor R6 to maintain the constant current. The amplitude of this current is set by resistor divider R4/R5. Thus, a constant current sine wave is delivered to the conductivity probe via CONN1, pin 1.

The ATTENUATED sine wave is picked up via CONN1, pin 1 and is fed into integrator IC (U2) which is an instrumentation amplifier. The signal is then routed to both a transmission gate (U4-A) and into another OP AMP (U3-D) is used as an inverter. This inverted signal is then coupled into another transmission gate (U4-D) which is summed with the signal from transmission gate U4-A. The null signal from the probe is coupled into OP AMP (U3-B) and its output is coupled into both another OP AMP (U3-C) and transmission gate (U4-C). The output of the OP AMP U3-C is summed with the output of the transmission gate U4-C. The conduction of the transmission gates of U4 are directed by the phase characteristics from the fed signal into the probe. Phase 0 is the positive phase and Phase 1 is the cosine. These signals are generated by analog comparators U9-A and U9-B. this part of the controller comprises a synchronous rectifier. This kind of rectifier provides a high quality of signal with little error. The conductivity signal, as well as its reference, is routed to the transmission gates of U5.

It should be noted that conductivity is dramatically influenced by temperature. Therefore a temperature sensing device is located in the probe. It has a voltage of approximately 10 millivolts per degree F. This signal, and its reference which is generated by U6, are gated through transmission gates of U5.

The OP AMP U3-A provides the steering for which this signal and its reference reaches the analog converter (U8). The CONTROL input determines which signal is routed through U5. This is accomplished by taking a logic level and converting this logic to a signal which can be used by the transmission gates of U5. When this control signal is high (5 volts) the signal from the temperature sensor is gated through the gates and routed to the converter U8.

The processor (U7) takes command from the switch array SW1-SW5. The commands are: INCREMENT (SW5) (which increases the setpoint at which the valve is triggered), DECREMENT (SW4) (which decreases the setpoint), ADJUST VALVE OFF SETPOINT (SW3) (which adjusts the off point), ADJUST VALVE ON SETPOINT (SW2) (which adjusts the on point), and ACTIVATE VALVE (SW1) (which manually activates the valve). These switches are read by the processor (U7) and take the appropriate action. The value which is read by the analog converter is displayed on DISPI1-DISP4. The discrete LEDs LED1-LED3 are indicative for the actions of the valve on, valve off and valve activate respectively.

Altogether, the conductivity module in the present invention determines conductivity in a unique way by establishing a known sine wave level with is then attenuated by the actual conductivity of an unknown liquid solution. The overall accuracy of the conductivity determination is further enhanced through the use of a synchronous rectifier circuit and a temperature stable oscillator circuit which provides high signal quality with little error.

In view of the above, it will be seen that the several objects of the invention are achieved and other advantageous results are obtained. As various changes could be made in the above constructions without departing from the scope of the invention, it is intended that all matter contained in the above description or shown in the accompanying drawings shall be interpreted as illustrative and not in a limiting sense.

What I claim is:

1. An apparatus for removal of electrolytic energy from fluids within fluid handling devices, comprising:
a control unit to monitor and adjust the conditions of a fluid within a fluid handling device; and
a grounding apparatus.

2. The apparatus for removal of electrolytic energy from fluids within fluid handling devices of claim 1 wherein the grounding apparatus has a conductive member, the conductive member having an inserted end, an outer surface, and means for non-conductively mounting the conductive member to the fluid handling device, the grounding apparatus further having an insulated conductor extending into and through the non-conductive mounting means, the insulated conductor extending full length through the conductive member and connected to the inserted end of the conductive member.

3. The apparatus for removal of electrolytic energy from fluids within fluid handling devices of claim 2 further comprising a rod-like member projecting upwardly from the outer surface of the conductive member and extending longitudinally thereof, with the rod-like member being wound around the outer surface of the conductive member in a helical manner.

4. The apparatus for removal of electrolytic energy from fluids within fluid handling devices of claim 3 wherein the control unit comprises a first circuit for periodically disconnecting the apparatus from the electrical ground, integrating a voltage measurement obtained from the apparatus, and then displaying the result of the voltage measurement.

5. The apparatus for removal of electrolytic energy from fluids within fluid handling devices of claim 4 wherein the first circuit means includes a millivolt probe controller circuit, comprising:
means for initially draining a charge from the grounding apparatus;
means for isolating the grounding apparatus from a natural ground;
means for automatically initiating a measurement cycle which measures a millivolt value of the grounding apparatus;
means for manually initiating the measurement cycle;
means for indicating that the millivolt measurement cycle has begun;
means for displaying a detected millivolt value of voltage built up on the grounding apparatus;
means for comparing the detected millivolt value with a preset minimum millivolt value;
means for comparing the detected millivolt value with a set of four previously detected millivolt values; and
means for indicating the detected millivolt value is less than one of either the preset minimum millivot value or the set of four previously detected millivolt values.

6. The apparatus for removal of electrolytic energy from fluids within fluid handling devices of claim 5 further comprising a second circuit means to control a current flow to a pair of electrodes thereby selectively releasing one of either copper or silver ions into the fluid, the second circuit means being capable of adjusting the current flow to compensate for a reduction in mass of the electrodes to obtain a desired ion dispersion level.

7. The apparatus for removal of electrolytic energy from fluids within fluid handling devices of claim 6 wherein the second circuit means includes a bio-cide module, comprising:
at least one electrode containing on of either silver metal or copper metal; and
a controller capable of supplying twelve volts at a current of three amps to the at least one electrode, the controller comprising:
means for initiating a toxin release cycle to control the growth of at least one unwanted organism within the fluids of the fluid handling device, the toxic release cycle being initiated upon completion of a preprogrammed interval related to one of either a time period or an energy density;
means for applying direct current electricity in a first polarity to the at least one electrode for a preprogrammed period of time;
means for applying direct current electricity in a second polarity to the at least one electrode for the preprogrammed period of time, the second polarity being the reverse polarity of the first polarity;
means for manually setting the preprogrammed period of time;
means for displaying the preprogrammed period of time;
means for reading an initial current draw in the at least one electrode at the initiation of a first toxin release cycle;
means for displaying the initial current draw from the at least one electrode;
means for comparing the initial current draw from that at least one electrode at the initiation of the first toxin release cycle with a subsequent current draw from the at least one electrode during a subsequent toxin release cycle; and
means for adjusting the preprogrammed period of time until the subsequent current draw substantially equals the initial current draw.

8. The apparatus for removal of electrolytic energy from fluids within fluid handling devices of claim 7 further comprising a third circuit means for detecting one of either a fluid conductivity level or a mineral content level which exceeds a predetermined value, and further comprising means for opening a valve to flush away a sediment deposit located within the fluid handling device.

9. The apparatus for removal of electrolytic energy from fluids within fluid handling devices of claim 8 wherein the third circuit means includes a conductivity module, comprising:
a conductivity probe;
a temperature sensing device located in the conductivity probe;
means for delivering a constant current sine wave value to the conductivity probe;
means for determining an electrical conductivity value of the fluid within the fluid handling device;
means for comparing the constant current sine wave value with the electrical conductivity value of the fluid in the fluid handling device; and
means for activating a sediment release valve when the electrical conductivity value of the fluid exceeds the constant current sine wave value, the sediment release valve being capable of one of either flushing, or draining, or both flushing and draining, a sediment accumulation located within the fluid handling device.

10. An apparatus for removal of electrolytic energy from fluids within fluid handling devices, comprising:
a grounding apparatus;
a first circuit means for automatically measuring and displaying the level of electrostatic charge present in a fluid in a fluid handling device;
a second circuit means which, by controlled addition of one of either copper ions or silver ions to the fluid, reduces fouling within the fluid by controlling the growth of at least one unwanted organism; and
a third circuit means to monitor the conductivity and mineral content of the fluid, and to automatically drain accumulated sediment from the fluid handling device when a predetermined conductivity level is attained.
